(19) United States
(12) Patent Application Publication
(10) Pub. No.: US 2010/0011384 A1
(43) Pub. Date: Jan. 14, 2010

(54) CRACK-PROOF DEVICE FOR AN OPTICAL DISK DRIVE

(76) Inventors: Guo-Wei Huang, Taoyuan County (TW); Hsien-Chung Ou, Taoyuan County (TW); Jen-Chen Wu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/427,766

(22) Filed: Apr. 22, 2009

(30) Foreign Application Priority Data
Jul. 14, 2008 (TW) 097126718

(51) Int. Cl. G11B 33/02

(52) U.S. Cl. 720/603; 720/655; G9B/33.002

(57) ABSTRACT

The invention provides a crack-proof device for an optical disk drive. The crack-proof device includes a casing whereon an opening is formed on a front end. The crack-proof device further includes a plank row extending downward from an upper edge of the opening for blocking the opening partly, a tray disposed inside the casing in a slidable manner, whereon a recession is formed for loading an optical disk, and at least one block wall protruding from an upper surface of the tray and located between an front end of the tray and the recession. When the tray is positioned inside the casing, the block wall and the plank row are staggered for reducing a vertical gap between them.

### BACKGROUND OF THE INVENTION

1. Field of the Invention

The present invention relates to an optical disk drive, and more particularly, to a crack-proof device for an optical disk drive when an optical disk rotates in an optical disk drive.

2. Description of the Prior Art

An optical disk is made of plastic material that is easily deformed due to manufacturing defects, material defects, deterioration, temperature change, and so on. When an optical disk drive is reading data on the optical disk with high speed rotation, the optical disk is easily broken by violent vibration so as to hurt a user.

As shown in FIG. 1, FIG. 1 is a section view of a conventional optical disk drive 1 disclosed in U.S. Pat. No. 2004081056. The optical disk drive 1 includes a casing 2, a wall 3, a tray 4 for supporting an optical disk 5, a door 6, and a panel 7. In order to prevent a fragment of the optical disk 5 from hurting the user, the optical disk drive 1 utilizes a crack-proof device. The wall 3 is extended from a front edge of the casing 2 for blocking an opening of the optical disk drive 1, and a bottom of the wall 3 is as close to an upper surface of the tray 4 as possible while the tray 4 is sliding in/out the casing 2 and vibration of the tray 4 keeps normal. The panel 7 disposed on a front end of the wall 3, the door 6 pressed on the panel 7, and the casing 2 form a closed space inside the casing 2. When the tray 4 slides in the optical disk drive 1, the optical disk 5 is rotated with a high speed inside the space so that the casing 2 made of metal material, and the door 6 and panel 7 made of plastic material are used for preventing the fragment of the optical disk 5 from ejecting out of the optical disk drive 1 so as to hurt the user.

However, it is necessary to form a gap P between the wall 3 and the upper surface of the tray 4 so that the tray 4 can slide in/out the optical disk drive 1 normally. The gap P has a predetermined width so as to allow the tray 4 vibrating inside the casing 2 without hitting to each other. The hitting affects operation of the optical disk drive 1 and makes noise. Furthermore, the fragment of the optical disk 5 may eject out of the optical disk drive 1 through the gap P. Although the door 6 and the panel 7 can be used for blocking the fragment of the optical disk 5, the door 6 and the panel 7 made of plastic material are easily broken after several times of hitting by fragments of the optical disk 5, so that the user might be hurt by the fragment of the optical disk 5 ejecting from the optical disk drive 1 through the gap P.

In addition, the door 6 and the panel 7 are customized components designed according to the main frame. The door 6 and the panel 7 are not installed on the optical disk drive 1 in a factory except in a custom-order process. Therefore, in a process of manufacturing, fabricating, and testing, the optical disk drive 1 without the door 6 and the panel 7 is only installed with the casing 2 and wall 3 for protection. The fragment of the optical disk 5 is easily ejected out of the casing 2 through the gap P to hurt the user. Thus, a structure of the crack-proof device has an important safety issue in the optical disk drive of the prior art.

### SUMMARY OF THE INVENTION

According to the claimed invention, a crack-proof device for an optical disk drive includes a casing, whereon an opening and a plank row are formed, the opening being formed on a front end of the casing, and the plank row being extending downward from an upper edge of the casing for blocking the opening partly, a tray disposed inside the casing in a slidable manner, whereon a recession is formed for loading an optical disk, and at least one block wall protruding from an upper surface of the tray and located between an front end of the tray and the recession. The plank row and the block wall are staggered when the tray is positioned inside the casing and a vertical gap is reduced between the plank row and the block wall.

According to the claimed invention, the incline of top of the block wall protruding from an upper surface of the tray is utilized to guide a fragment of an optical disk to the plank row to prevent a fragment of an optical disk from flying out.

According to the claimed invention, a crack-proof device for an optical disk drive includes a casing, whereon an opening and a plank row are formed, the opening being formed on a front end of the casing, and the plank row being extending downward from an upper edge of the casing for blocking the opening partly, a tray disposed inside the casing in a slidable manner, whereon a recession is formed for loading an optical disk, and a block wall protruding from an upper surface of the tray and located between an front end of the tray and the recession. The plank row and the block wall are staggered when the tray is positioned inside the casing, and the plank row is bent between the block wall and the recession for preventing a fragment for an optical disk from ejecting to enhance the safety.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a section view of an optical disk drive in the prior art.

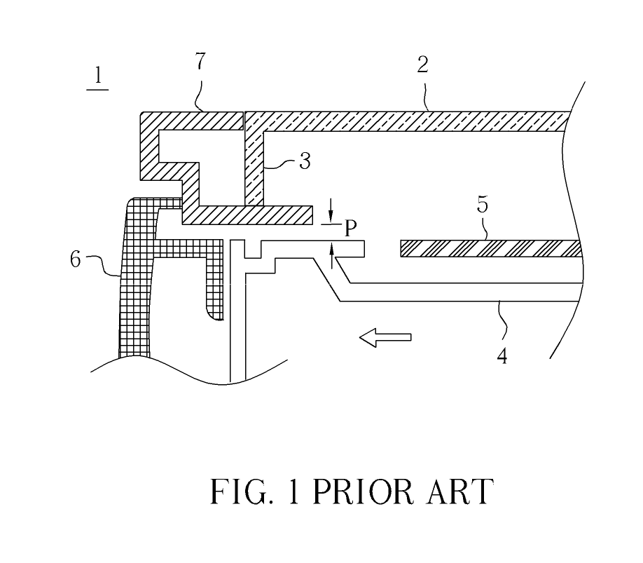

FIG. 2 is a diagram of a crack-proof device for an optical disk drive according to a first embodiment of the present invention.

FIG. 3 is a sectional view of the optical disk drive according to the first embodiment of the present invention.

FIG. 4 is an operating diagram of the crack-proof device of the operating optical disk drive according to the first embodiment of the present invention.

FIG. 5 is a sectional view of a crack-proof device for the optical disk drive according to a second embodiment of the present invention.

FIG. 6 is a sectional view of a crack-proof device for the optical disk drive according to a third embodiment of the present invention.

FIG. 7 is a sectional view of a crack-proof device for the optical disk drive according to a fourth embodiment of the present invention.

FIG. 8 is a sectional view of a crack-proof device for the optical disk drive according to a fifth embodiment of the present invention.

### DETAILED DESCRIPTION

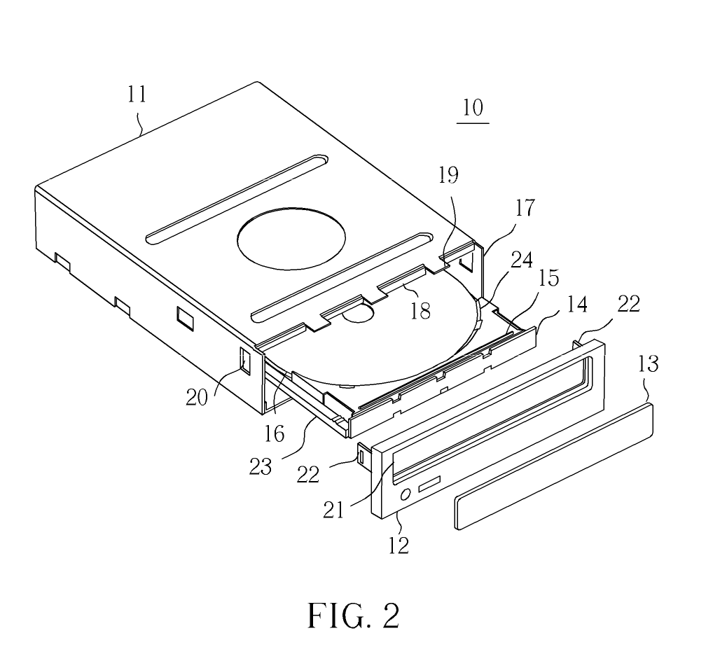

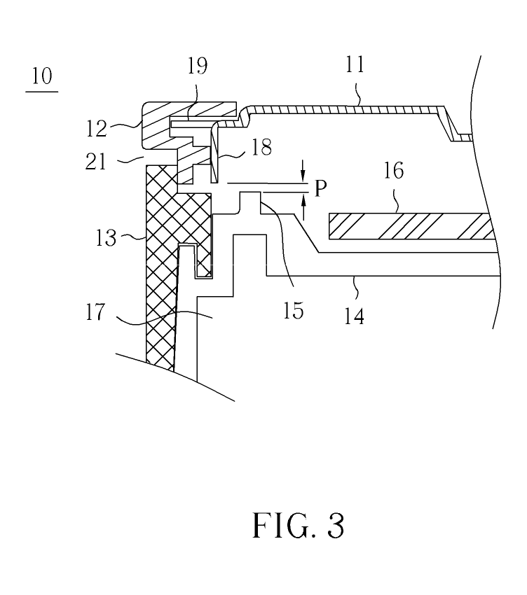

Please refer to FIG. 2 and FIG. 3. FIG. 2 is a diagram of a crack-proof device for an optical disk drive 10 according to a first embodiment of the present invention. FIG. 3 is a sectional view of the optical disk drive 10 according to the first embodiment of the present invention. The optical disk drive 10 includes a casing 11, a panel 12, a door 13, a tray 14, and a block wall 15. The panel 12 is disposed on a front end of the casing 11 for connecting with the tray 14 and the door 13. The tray 14 is for loading an optical disk 16 and slides in/out the optical disk drive 10 in a slidable manner. The block wall 15 protrudes from an upper surface of the tray 14.

The casing 11 is a box with high material intensity, such as metal material. An opening 17 is formed on the front end of the casing 11. A plank row 18 is extended downward a predetermined distance from an upper edge of the casing 11 for blocking the opening 17 partly. The plank row 18 includes a plurality of planks. A plurality of braces 19 having smaller lengths is extended between the plank row 18. Two engaged slots 20 are formed on two sides of the casing 11 adjacent to the opening 17, respectively. An outlet 21 in a long-slot shape is formed on a middle of the panel 12 according to a shape of the opening 17. Two engaging hooks 22 are formed on two sides of the panel 12 for engaging with the two engaged slots 20, respectively. As shown in FIG. 3, the panel 12 is disposed on the opening 17 and the plurality of braces 19 for connecting to the casing 11 and blocking the opening 17 of the casing 11, so that a hollow space is formed inside the casing 11.

Please refer to FIG. 2, the tray 14 is disposed inside the hollow space of the casing 11 and supported by a sliding track 23. The tray 14 can slide in/out the casing 11 through the outlet 21. The door 13 is connected to a front end of the tray 14 and can be wedged into the outlet 21 as shapes of the door 13 and the outlet 21 are matched. A circle recession 24 is formed on the tray 14 for loading the optical disk 16. The block wall 15 can include a plurality of walls arranged in parallel or be composed of a single wall. The block wall 15 protrudes from the upper surface of the tray 14 and is located between the front end of the tray 14 and the recession 24. In this embodiment, one block wall 15 is used and can be integrated with the tray 14 monolithically for cost-down. As shown in FIG. 3, when the tray 14 is positioned inside the optical disk drive 10, the door 13 is wedged into the outlet 21 and holds the panel 12. The block wall 15 protruding from the tray 14 and the plank row 18 extended downward from the casing 11 are staggered. A vertical gap P is formed between the block wall 15 and the plank row 18. Without hindering the tray 14 from sliding in/out the casing 11 normally, a top of the block wall 15 can be close to the plank row 18 as possible for reducing the gap P, so that the gap P is smaller than a thickness of the optical disk 16, such as 1.2 mm, for preventing a fragment of the optical disk 16 from ejecting out of the optical disk drive 10 through the gap P.

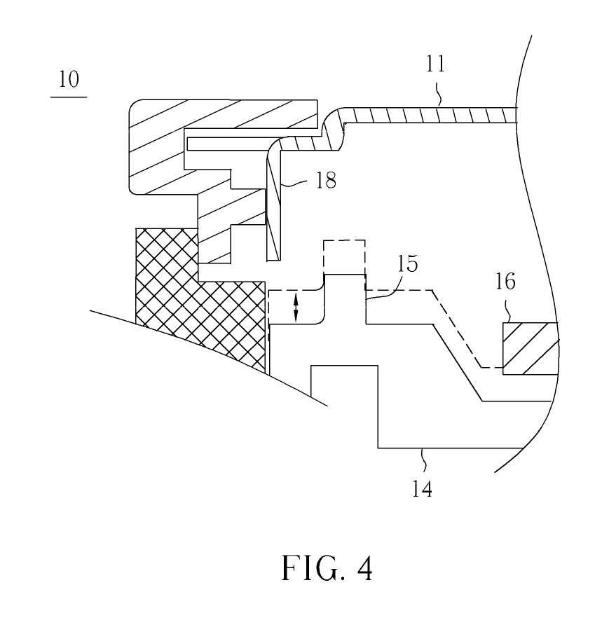

As shown in FIG. 4, FIG. 4 is an operating diagram of the crack-proof device of the operating optical disk drive 10 according to the first embodiment of the present invention. When the tray 14 is positioned inside the optical disk drive 10, vibration of the tray 14 generates due to rotation of the optical disk 16 at high speed, and amplitude of the tray 14 makes the block wall vibrate as a dotted line in FIG. 4. Because the block wall 15 protruding from the tray 14 and the plank row 18 extended downward from the upper edge of the casing 11 are staggered, the block wall 15 does not hit the plank row 18 to make noise and affect vibrational damping of the tray 14 even if the gap P is small. In addition, external vibration of the optical disk drive 10 does not transmit from the plank row 18 to the block wall 15 to strengthen the vibration of the tray 14 and to affect reading in/out function of the optical disk drive 10. Therefore, the crack-proof device for the optical disk drive 10 can utilize staggering structure of the block wall 15 protruding from the tray 14 and the plank row 18 extending downward from the upper edge of the casing 11 to reduce the gap P for preventing the fragment of the optical disk 16 from ejecting out of the optical disk drive 10 so as to improve protective effect of the crack-proof device.

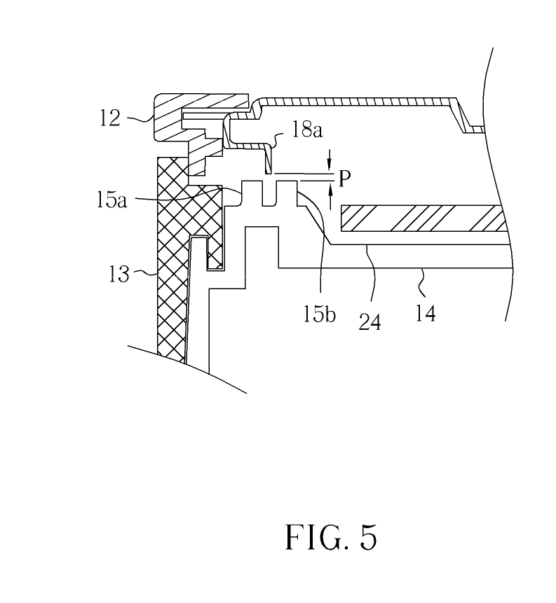

As shown in FIG. 5, FIG. 5 is a sectional view of the crack-proof device for the optical disk drive 10 according to a second embodiment of the present invention. The basic structure of this embodiment is the same as the first embodiment, and detail description is omitted herein for simplicity. Difference between the first embodiment and the second embodiment is that the block wall 15 includes two walls 15a and 15b arranged in parallel and protruding from the upper surface of the tray 14 in front of the recession 24. The two walls 15a and 15b have the same heights. A plank row 18a is extended downward from the upper edge of the casing 11 and staggered with the two walls 15a and 15b. The predetermined gap P is maintained between the plank row 18a and the two walls 15a and 15b. Therefore, the crack-proof device for the optical disk drive 10 of this embodiment can utilize the plurality of walls to strengthen a structure of the crack-proof device. The fragment of the optical disk 16 ejecting away from the optical disk drive 10 in an inclined direction can be blocked by the front wall 15a for preventing the fragment of the optical disk 16 from hitting the panel 12 and the door 13 directly and for improving the protective effect of the crack-proof device.

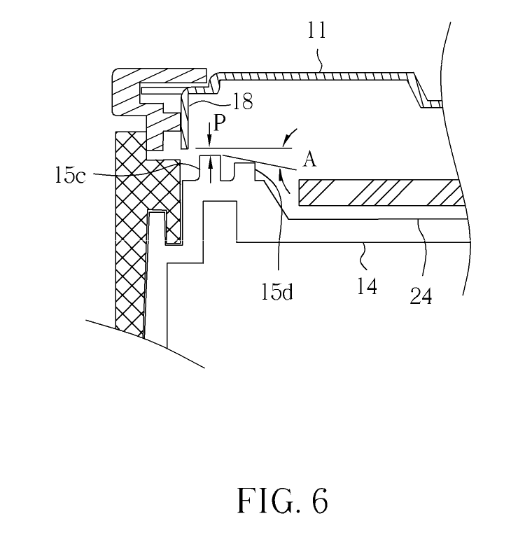

As shown in FIG. 6, FIG. 6 is a sectional view of the crack-proof device for the optical disk drive 10 according to a third embodiment of the present invention. The basic structure of this embodiment is the same as the first embodiment. Difference between the first embodiment and the third embodiment is that the block wall 15 includes two walls 15c and 15d arranged in parallel and protruding from the upper surface of the tray 14 in front of the recession 24. The wall 15c adjacent to the front end of the tray 14 is higher than the wall 15d. The two walls 15c and 15d located between the recession 24 and the plank row 18 extended downward from the upper edge of the casing 11 are staggered. The predetermined gap P is maintained between the plank row 18 and the higher wall 15c. A predetermined gradient A upwardly to an inner side of the plank row 18 is formed by the different heights of the two walls 15c and 15d. Therefore, the crack-proof device for the optical disk drive 10 of this embodiment can utilize the plurality of walls to strengthen the structure of the crack-proof device. The predetermined gradient A formed by the different heights of the two walls 15c and 15d can guide the fragment of the optical disk 16 to the inner side of the plank row 18, so that the fragment of the optical disk 16 is blocked by the casing 11 for preventing the fragment of the optical disk 16 from ejecting out of the optical disk drive 10.

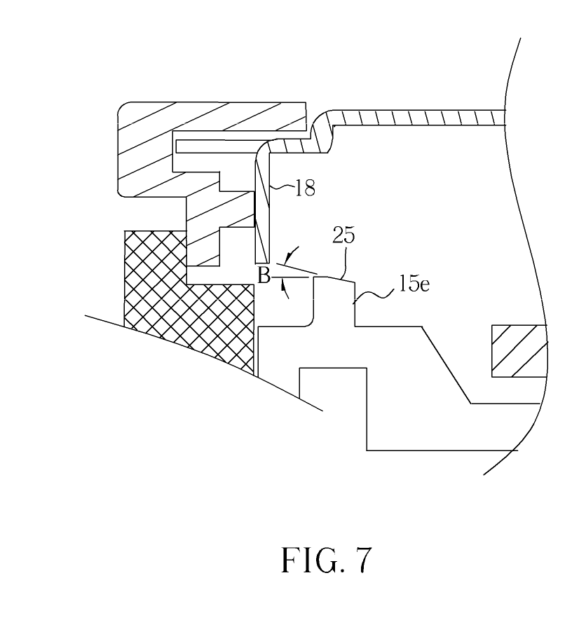

As shown in FIG. 7, FIG. 7 is a sectional view of the crack-proof device for the optical disk drive 10 according to a fourth embodiment of the present invention. The predetermined gradient A formed by the two walls having the different heights according to the third embodiment can be replaced by the structure of the fourth embodiment, which includes an inclined surface 25 with a predetermined gradient B being formed on an upper surface of a block wall 15e. The inclined surface 25 upwardly higher than the gap P can guide the fragment of the optical disk 16 to the inner side of the plank row 18 for preventing the fragment of the optical disk 16 from ejecting out of the optical disk drive 10.

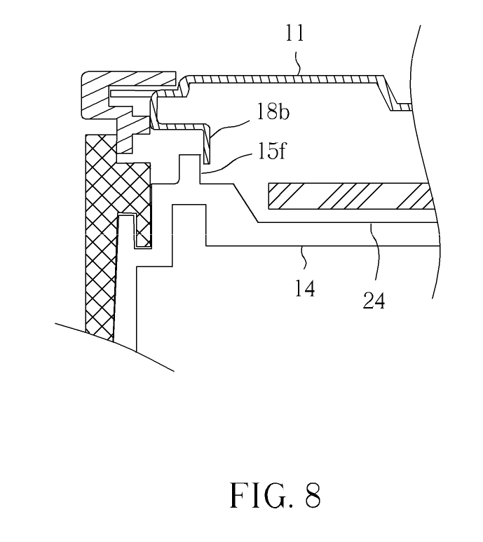

As shown in FIG. 8, FIG. 8 is a sectional view of the crack-proof device for the optical disk drive 10 according to a fifth embodiment of the present invention. The basic structure of this embodiment is the same as the first embodiment. Difference between the first embodiment and the fifth embodiment is that a plank row 18b is extended downward from the upper edge of the casing 11 and located between a block wall 15f and the recession 24. A height of the block wall 15f protruding from the upper surface of the tray 14 can be raised appropriately. A bottom of the plank row 18b and a top of the block wall 15f can be staggered in order to reduce a gap between the plank row 18b and the block wall 15f while a normal vibration of the tray 14 is not affected. Therefore, the fifth embodiment can utilize the plank row 18b extended downward to a rear of the block wall 15f protruding from the upper surface of the tray 14, so that the plank row 18b and the block wall 15f are staggered for blocking the gap between the plank row 18b and the block wall 15f and for preventing the fragment of the optical disk 16 from ejecting out of the optical disk drive 10.

Those skilled in the art will readily observe that numerous modifications and alterations of the device and method may be made while retaining the teachings of the invention.

What is claimed is:

1. A crack-proof device for an optical disk drive comprising:
a casing, whereon an opening and a plank row are formed, the opening being formed on a front end of the casing, and the plank row being extending downward from an upper edge of the casing for blocking the opening partly;
a tray disposed inside the casing in a slidable manner, whereon a recession is formed for loading an optical disk; and
at least one block wall protruding from an upper surface of the tray and located between an front end of the tray and the recession;
wherein the plank row and the block wall are staggered when the tray is positioned inside the casing and a vertical gap is formed between the plank row and the block wall.

2. The crack-proof device of claim 1, wherein the plank row and the block wall are staggered without restraining the tray from sliding in/out the casing.

3. The crack-proof device of claim 2, wherein the vertical gap is smaller than a thickness of the optical disk.

4. The crack-proof device of claim 1, wherein the block wall comprises two walls arranged in parallel.

5. The crack-proof device of claim 4, wherein the two walls of the block wall have the same height.

6. The crack-proof device of claim 4, wherein the plank row is bent between the two walls of the block wall as stagger.

7. The crack-proof device of claim 4, wherein the two walls of the block wall are disposed between the plank row and the recession when the tray is positioned inside the casing, and the wall adjacent to the front end of the tray is higher than the other.

8. The crack-proof device of claim 7, wherein a predetermined gradient upwardly to an inner side of the plank row is formed by the different heights of the two walls of the block wall.

9. The crack-proof device of claim 1, wherein an inclined plane with a predetermined gradient is formed on a top surface of the block wall for guiding a fragment of the optical disk to an inner side of the plank row.

10. The crack-proof device of claim 1, wherein the plank row comprises a plurality of planks.

11. The crack-proof device of claim 10, wherein a plurality of braces having smaller lengths is extended between the plurality of planks.

12. The crack-proof device of claim 1, wherein the block wall is integrated with the tray monolithically.

13. A crack-proof device for an optical disk drive comprising:
a casing, whereon an opening and a plank row are formed, the opening being formed on a front end of the casing, and the plank row being extending downward from an upper edge of the casing for blocking the opening partly;
a tray disposed inside the casing in a slidable manner, whereon a recession is formed for loading an optical disk; and
a block wall protruding from an upper surface of the tray and located between an front end of the tray and the recession;
wherein the plank row and the block wall are staggered when the tray is positioned inside the casing, and the plank row is bent between the block wall and the recession for reducing a vertical gap between the block wall and the plank row.

14. The crack-proof device of claim 13, wherein a bottom of the plank row overlaps a top of the block wall and be staggered with each other.

15. The crack-proof device of claim 13, wherein the block wall comprises two walls arranged in parallel.
